(19) United States
(12) Patent Application Publication
(10) Pub. No.: US 2004/0019649 A1
(43) Pub. Date: Jan. 29, 2004

(54) Mail server and electronic mail receiving terminal device

(75) Inventor: Yoshifumi Tanimoto, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 10/615,832

(22) Filed: Jul. 10, 2003

(30) Foreign Application Priority Data
Jul. 23, 2002 (JP) 2002-214137

(51) Int. Cl. G06F 15/16

(52) U.S. Cl. 709/206

(57) ABSTRACT

A mail server includes a POP mail box which stores received electronic mail by corresponding each of the electronic mail and an electronic mail address of a destination of each of the electronic mail, and an SMTP server which transmits electronic mail of a new mail notification to the electronic mail address of the destination of the received electronic mail by a push method protocol. The mail server also includes a distribution unit which distributes the electronic mail by a pull method protocol in accordance with a distribution request from the electronic mail address of the destination of the electronic mail stored in the mailbox. When receiving electronic mail, the received electronic mall is stored into the POP mailbox without distributing the received electronic mail immediately. When necessary, a new mail notification is carried out to an electronic mail address of a destination of the received electronic mail.

### FIELD OF THE INVENTION

The present invention relates to a mail server and an electronic mail receiving terminal device which receives electronic mail from the mail server.

### DESCRIPTION OF THE RELATED ART

Simple Mail Transfer Protocol (SMTP) and a Post Office Protocol (POP) are generally used as protocols for electronic mail. The SMTP is generally used for communication of electronic mail between mail servers. The SMTP is a so-called push method protocol in which electronic mail is automatically transmitted to an electronic mail address of a destination. Therefore, there is no delay in the reception of the electronic mail at a final destination. However, for example, when available capacity in a storage area of the electronic mail receiving terminal device of the destination is insufficient, there are cases when the electronic mail cannot be received.

Meanwhile, the POP is generally used when forwarding electronic mail received by a mail server to an electronic mail receiving terminal device. The POP is a so-called pull method protocol in which electronic mail is distributed to an electronic mail receiving terminal device from a mail server by executing polling to the mail server from the electronic mail receiving terminal device periodically or at a certain point of time. Therefore, there are problems, such as a delay in the distribution of electronic mail, or an extra load being placed on a communication line due to frequent occurrence of unnecessary polling.

Recently, various files are frequently transmitted and received as an attached file of electronic mail. Especially when using an Internet facsimile machine which transmits and receives image data for facsimile communication as an attached file of electronic mail, since image data is attached as an attached file of electronic mail, the amount of data becomes large. Therefore, when distributing the electronic mail by the SMTP to the Internet facsimile machine which is an electronic mail receiving terminal device, a sufficient capacity becomes necessary to be available in the storage area of the receiving terminal device. To avoid such a state, when distributing the electronic mail to the Internet facsimile machine by the POP, there are problems that the electronic mail is not distributed to the terminal device immediately after the electronic mail arrives at the mail server.

### SUMMARY OF THE INVENTION

The present invention was made in consideration to the above-described circumstance. An advantage of the present invention is to provide a mail server and an electronic mail receiving terminal device, wherein a new mail notification of electronic mail which is a relatively small amount of data is transmitted to the terminal device from the mail server by a push method protocol such as SMTP, and the terminal device which received the new mail notification receives the electronic mail by a pull method protocol such as POP according to necessity or according to an available capacity in a storage area of the terminal device.

A mail server of the present invention includes a mailbox which stores received electronic mail by corresponding each of the electronic mail and an electronic mail address of each of the destinations. In addition, the mail server includes a new mail notification unit which transmits a new mail notification to an electronic mail address of the destination of the received electronic mail by a push method protocol. The mail server also includes a distribution unit which distributes the electronic mail by a pull method protocol according to a distribution request from an electronic mail address of the destination of the electronic mail stored in the mailbox.

In the above-described mail server of the present invention, when receiving electronic mail, the received electronic mail is stored into the mailbox without being distributed immediately. In addition, a new mail notification is transmitted to the electronic mail address of the destination of the received electronic mail by the push method protocol. Then, when receiving a distribution request, the electronic mail is distributed by the pull method protocol.

Therefore, when it is necessary, the received electronic mail can be distributed immediately to the electronic mail receiving terminal device. When it is not necessary, or when the electronic mail cannot be received due to circumstances such as a lack of available capacity in a storage area for the electronic mail at the terminal device side, the electronic mail can be saved in the mail server.

Moreover, when the electronic mail address of the destination of the received electronic mail is an electronic mail address designated in advance, the new mail notification unit transmits electronic mail of a new mail notification by the push method protocol. Therefore, the new mail notification can be received only when it is necessary, and the new mail notification is not received when it is not necessary.

When the received electronic mail is electronic mail of the type which is designated in advance, the new mail notification unit transmits electronic mail of a new mail notification by the push method protocol. Therefore, for example, the new mail notification can be received only for the electronic mail which an attached file is attached and which the amount of data is relatively large.

The new mail notification unit notifies the amount of data of the received electronic mail by electronic mail of a new mail notification. Therefore, when an available capacity in the storage area for the electronic mails in the electronic mail receiving terminal device is small, electronic mail can be saved in the mailbox without requesting a distribution.

An electronic mail receiving terminal device of the present invention includes a reception unit which receives electronic mail of a new mail notification which notifies that electronic mail is stored in the mailbox of the mail server by a push method protocol. In addition, the electronic mail receiving terminal device includes a distribution requesting unit which requests the mail server to distribute the electronic mail by the pull method protocol when receiving the new mail notification.

A fact that an electronic mail addressed to the electronic mail receiving terminal device is stored in the mailbox of the mail server can be notified to the electronic mail receiving terminal device by electronic mail of the new mail notification by the push method protocol. Therefore, when it is necessary, the distribution of the electronic mail can be requested immediately to the mail server. When it is not necessary, or when the electronic mail cannot be received due to circumstances such as lack of available capacity in the storage area for the electronic mail addressed to the electronic mail receiving terminal device, the electronic mail can be saved in the mail server without requesting a distribution.

The electronic mail receiving terminal device of the present invention further includes a printing unit which prints the received electronic mail as a hardcopy. When the printing unit can carry out a printing operation, and when receiving the new mail notification, the distribution requesting unit requests the mail server to distribute the electronic mail by the pull method protocol. Therefore, when, it is necessary to make a hardcopy of the distributed electronic mail immediately, for example, when receiving image data of a facsimile communication as an attached file the electronic mail, the electronic mail receiving terminal device can receive the electronic mail under a state in which a hardcopy can be made by the printing unit.

The electronic mail receiving terminal device of the present invention further includes a storage unit which stores the received electronic mail. When the available capacity in the storage unit is a prescribed capacity or more, and when receiving the new mail notification, the distribution requesting unit requests the mail server to distribute the electronic mail by the pull method protocol. Therefore, the electronic mail can be saved in the mail server, without being distributed forcibly by the push method protocol regardless of the circumstance that the electronic mail cannot be received.

The electronic mail receiving terminal device of the present invention further includes a storage unit which stores the received electronic mail, and a comparing unit. When receiving the new mail notification, the comparing unit compares the amount of data notified by the received electronic mail of the new mail notification, and the available capacity in the storage unit. When the amount of data notified by the new mail notification is less than the available capacity in the storage unit, the distribution requesting unit requests the mail server to distribute the electronic mail by the pull method protocol. Therefore, the electronic mail can be saved in the mail server without being distributed forcibly by the push method protocol regardless of the circumstance that the electronic mail cannot be received.

### BRIEF DESCRIPTION OF THE DRAWINGS

FIG. 1 is a schematic diagram showing a network configuration which includes a mail server and an electronic mail receiving terminal device of the present invention.

FIG. 2 is a block diagram showing an example of an inner configuration of the mail server and a connected state of the mail server with remote devices.

FIG. 3 is a schematic diagram showing memory contents of a hard disk of the mail server.

FIG. 4 is a schematic diagram showing an example of registered contents of a mailbox management table.

FIG. 5 is a block diagram showing an example of an inner configuration of an Internet facsimile machine, which is an example of the electronic mail receiving terminal device of the present invention, and a connected state of the Internet facsimile machine with remote devices.

FIG. 6 is a schematic diagram showing memory contents of a hard disk of the Internet facsimile machine.

FIG. 7 is a functional block diagram which schematically shows a communication function of electronic mail between the mail server and the Internet facsimile machine.

FIG. 8 is a schematic diagram showing an example of a new mail notification.

FIG. 9 is a flowchart showing a processing procedure for describing an operation of the mail server.

FIG. 10 is a flowchart showing a processing procedure for describing an operation of the Internet facsimile machine.

### DETAILED DESCRIPTION OF THE PREFERRED EMBODIMENTS

Embodiments of the present invention will be described with reference to the accompanying drawings.

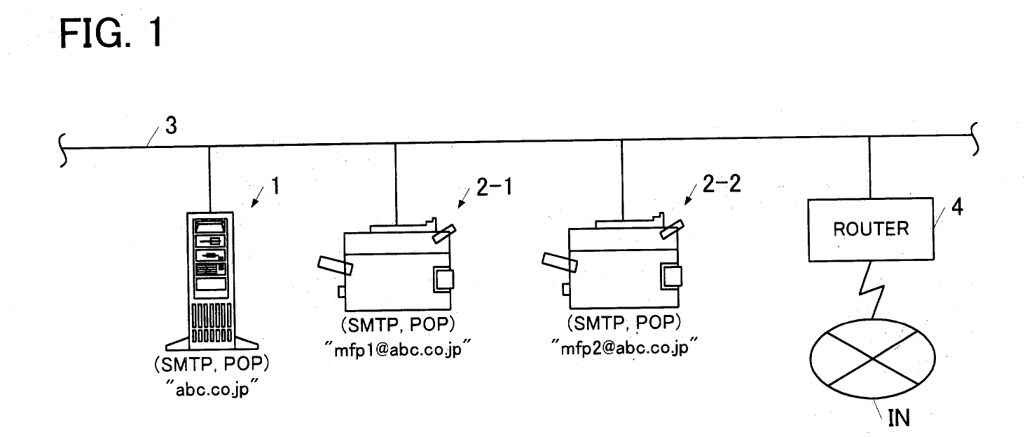

FIG. 1 is a schematic diagram showing a network configuration which includes a mail server 1, and an electronic mail receiving terminal device 2, such as an Internet facsimile machine, of the present invention. In FIG. 1, for convenience of description, two Internet facsimile machines 2-1, 2-2 are connected to the mail server 1 via a Local Area Network. (LAN) 3. However, a larger number of Internet facsimile machines can be connected to the LAN 3, and a personal computer or the like can be connected to the LAN 3 as an electronic mail receiving terminal device.

The mail server 1 is connected to the Internet facsimile machines 2 (2-1, 2-2) via the LAN 3. The mail server 1 is also connected to the Internet IN via a router 4 which is connected to the LAN 3. Therefore, the mail server 1 can transmit electronic mail to the Internet IN via the router 4, and receive electronic mail from the Internet IN via the router 4 and the LAN 3. In addition, the mail server 1 can transmit and receive electronic mail with a plurality of Internet facsimile machines 2 which are connected to the LAN 3.

Further, although not shown in the drawings, several mail servers, personal computers, Internet facsimile machines or the like can be connected to the Internet IN. Therefore, the mail server 1 can transmit and receive electronic mail with a plurality of Internet facsimile machines 2 via the LAN 3. Moreover, the mail server 1 can transmit and receive electronic mail with other mail servers, personal computers, and Internet facsimile machines or the like via the Internet IN.

Further, the mail server 1 can transmit and receive electronic mail by both the SMTP which is the push method electronic mail protocol, and the POP which is the pull method electronic mail protocol. Moreover, each of the Internet facsimile machines 2 can transmit and receive electronic mail by both the SMTP and the POP.

Here, a domain of the mail server 1 is “abc.co.jp”, an electronic mail address of the Internet facsimile machine 2-1 is “mfp1@abc.co.jp”, and an electronic mail address of the other Internet facsimile machine 2-2 is “mfp2@abc.co.jp”.

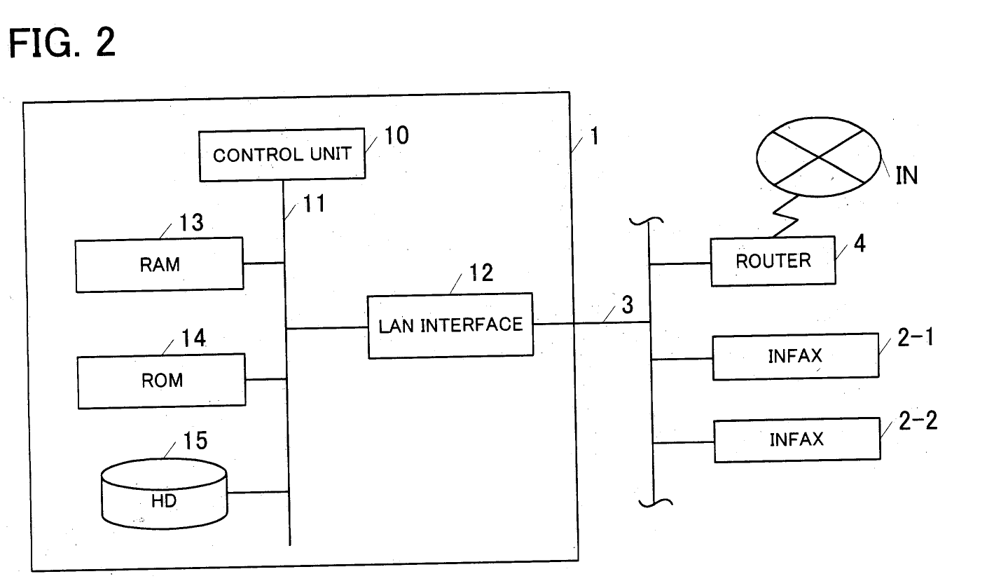

FIG. 2 is a block diagram showing an example of an inner configuration of the mail server 1 and a connected state of the mail server 1 with remote devices.

The mail server 1 is basically formed as a general computer system, and functions as a mail server by an installed application program.

A control unit 10 of the mail server 1 is formed as a Central Processing Unit (CPU). The control unit 10 is connected to a LAN interface 12, a Random Access Memory (RAM) 13, a Read Only Memory (ROM) 14, a hard disk (HD) 15 which is an inner storage unit, or the like via a bus 11, and controls each of the connected parts. Further, other than the parts illustrated in the drawing, the mail server 1 can also include an operation unit such as a keyboard or a mouse, and a display or the like for the purpose of maintenance and monitoring.

The LAN interface 12 is an interface for the mail server 1 to carry out communication with the Internet facsimile machine 2 and the router 4 via the LAN 3. The LAN interface 12 is connected to the Internet IN via the router 4. The LAN interface 12 can carry out communication such as a transmission and a reception of electronic mail with another mail server, Internet facsimile machine, personal computer or the like via the Internet IN.

The RAM 13 is formed from a Static Random Access Memory (SRAM), a flash memory or the like. The RAM 13 stores temporary data that is generated when software is executed by the control unit 10. The ROM 14 stores firmware, constant data or the like in advance for the control unit 10 to carry out a control operation.

The HD 15 to be described later functions as a mailbox. The mail server 1 stores the received electronic mail addressed to the Internet facsimile machines 2 (2-1, 2-2) once in the mailbox set in the HID 15, without distributing the electronic mail immediately.

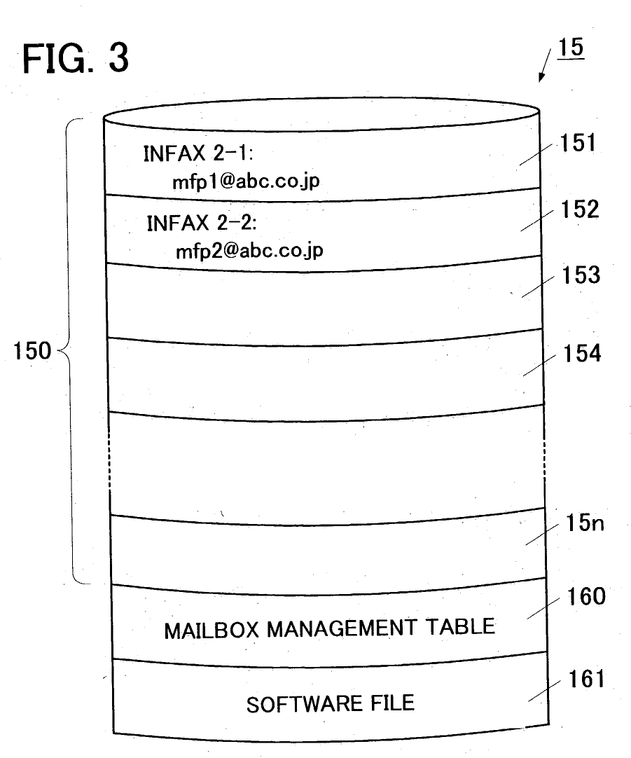

FIG. 3 is a schematic diagram showing the memory contents of the HD 15 of the mail server 1. Mailboxes 150 are set in appropriate areas in the HD 15. The mailboxes 150 are divided for each domain, specifically to support each of the Internet facsimile machines (INFAX) 2-1, 2-2, . . . which are the electronic mail receiving terminal device. In the example shown in FIG. 3, the mailbox 150 includes a first mailbox 151 which the domain is INFAX 2-1, and a second mailbox 152 which the domain is INFAX 2-2. The mailbox 150 also includes mailboxes (up to 15 n) for all domains which are subject of distribution by the mail server 1.

Moreover, a mailbox management table 160 is set at an appropriate area in the HD 15. Furthermore, a software file 161 of a program that is installed for a computer system to function as the mail server 1 is stored in an appropriate area of the HD 15.

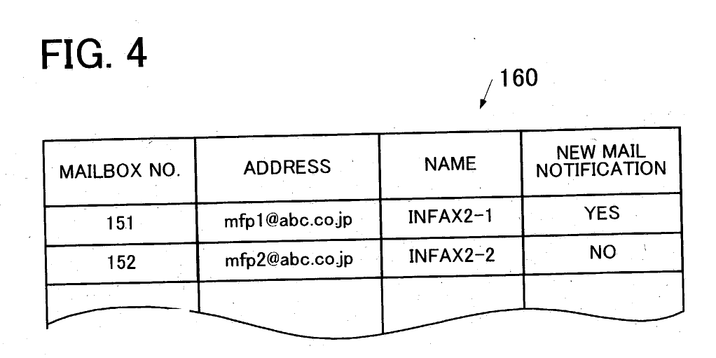

FIG. 4 is a schematic diagram showing an example of registered contents of the mailbox management table 160. The mailbox management table 160 stores information such as mailbox numbers (NO.) 151, 152 . . . for each of the mailboxes within the mailbox 150, electronic mail addresses “mfp1@abc.co.jp”, “mfp2@abc.co.jp” . . . for each of the mailbox numbers, name of each of the devices INFAX 2-1, INFAX 2-2 . . . , and information which designates whether or not to carryout a new mail notification to each of the devices. In the example shown in FIG. 4, the mailbox management table 160 is registered to carry out a new mail notification to the Internet facsimile machine with the mailbox number 151, the electronic mail address “mfp1@abc.co.jp”, and the name INFAX 2-1. Moreover, it is registered not to carry out a new mail notification to the Internet facsimile machine with the mailbox number is 152, the electronic mall address “mfp2@abc.co.jp”, and the name INFAX 2-2.

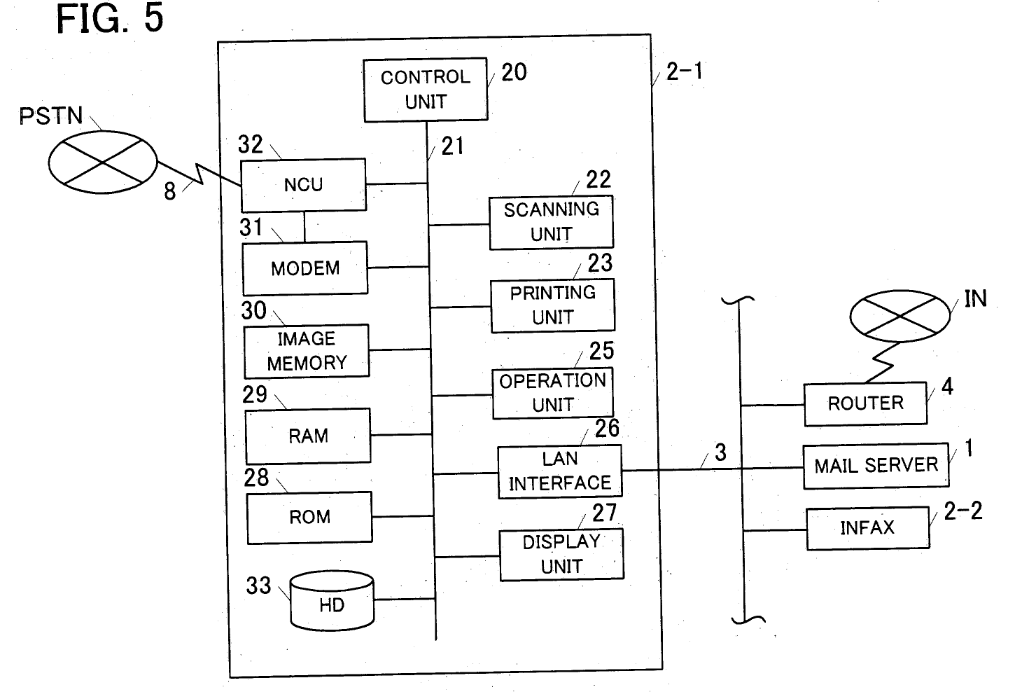

FIG. 5 is a block diagram showing an example of an inner configuration of the INFAX 2-1 and a connected state of the INFAX 2-1 with remote devices. Further, the other INFAX 2-2 basically has the same configuration.

A control unit 20 of the INFAX 2-1 is formed from a CPU. The control unit 20 is connected to a scanning unit 22, a printing unit 23, an operation unit 25, a LAN interface 26, a display unit 27, a ROM 28, a RAM 29, an image memory 30, a modem 31, a Network Control Unit (NCU) 32, a hard disk (HD) 33 which is an inner storage unit, or the like via a bus 21. The control unit 20 controls each of the connected parts, and executes various software functions in accordance with firmware which is stored in the ROM 28 in advance.

The scanning unit 22 is a scanner using a Charge Coupled Device (CCD) or the like. The scanning unit 22 scans an original, and stores the scanned image to the image memory 30 via the bus 21.

The printing unit 23 is an electro-photographic typed printer in the present embodiment. Although not shown in the drawings, the printing unit 23 is like a general electro-photographic typed printer. That is, a recording paper is taken out from a cassette which stores recording papers, and a developing unit forms a toner manifest image by developing an electrostatic latent image of the image information formed on a photoconductive drum. Then, by transferring the toner manifest image to the recording paper and fixing the image, the image information is printed (as a hardcopy). The printing unit 23 can be a printer other than the electro-photographic typed printer. For example, the printing unit 23 can be an inkjet printer.

The LAN interface 26 is an interface for the INFAX 2-1 to carry out communication with the INFAX 2-2 and the mail server 1 via the LAN 3. The LAN interface 26 is also connected to the Internet IN via the router 4, and can carry out communication with other Internet facsimile machines, personal computers or the like.

The operation unit 25 includes letter keys, a ten-key numeric pad, speed-dial keys, one-touch dial keys, and various function keys or the like which are necessary for operating the INFAX 2-1. The display unit 27 is a display device such as a liquid crystal display or a Cathode Ray Tube (CRT) display. The display unit 27 can display an operation status of the INFAX 2-1, and also image data of an original scanned by the scanning unit 22, image data of an original received from a remote device, image data of an attached file of electronic mail stored in the HD 33, or the like.

The RAM 29 is formed from an SRAM, a flash memory or the like. The RAM 29 stores temporary data that is generated when software is executed by the control unit 20, in other words, when the INFAX 2-1 operates. The image memory 30 is formed from a Dynamic Random Access Memory (DRAM) or the like. The image memory 30 temporarily stores image data of an original scanned by the scanning unit 22, image data received from a remote device, or the like.

The modem 31 is formed from a facsimile modem which can carry out a facsimile communication. The NCU 32 is directly connected to the modem 31. The NCU 32 is hardware which carries out closing and releasing operations of an analogue line 8 between the NCU 32 and a public switched telephone network PSTN. When necessary, the NCU 32 connects the modem 31 to the public switched telephone network PSTN to control the facsimile communication between the INFAX 2-1 and a remote facsimile machine.

Therefore, the INFAX 2-1 can transmit the image data of the original scanned by the scanning unit 22 to another facsimile machine by facsimile communication via the analogue line 8 and the public switched telephone network PSTN. Moreover, the INFAX 2-1 can transmit the image data of the original scanned by the scanning unit 22 as electronic mail to the Internet IN from the mail server 1 via the LAN 3.

Furthermore, the INFAX 2-1 stores in the HD 33, electronic mail addressed to the INFAX 2-1 that arrived at the mail server 1 by receiving the electronic mail distributed by a protocol to be described later. The electronic mail addressed to the INFAX 2-1 that arrived at the mail server 1 is electronic mail which was transmitted from another Internet facsimile machine, personal computer or the like via the Internet IN, and the router 4.

The HD 33 is set in advance with an area (an incoming mailbox 340) for storing received electronic mails. The HD 33 also stores a table or the like which stores facsimile numbers (telephone numbers), electronic mail addresses or the like which are registered by the speed-dial keys, the one-touch dial keys of the operation unit 25.

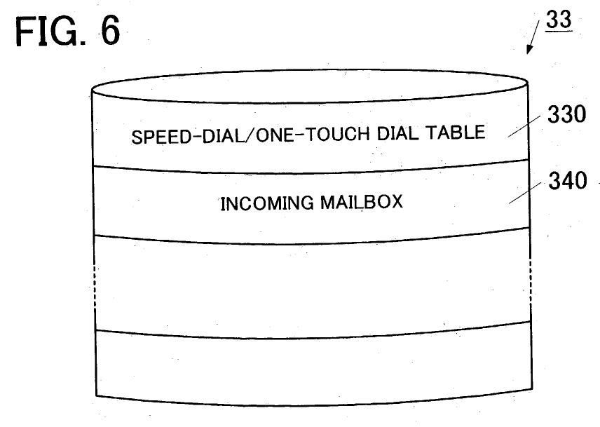

FIG. 6 is a schematic diagram showing memory contents of the HD 33 of the INFAX 2-1. The HD 33 is set with speed-dial/one-touch dial table 330, an incoming mailbox 340, and areas for storing other software programs or the like.

The electronic mail can be distributed rationally between the mail server 1 and the INFAX 2 by using the SMTP which is the push method electronic mail protocol, and the POP which is the pull method electronic mall protocol.

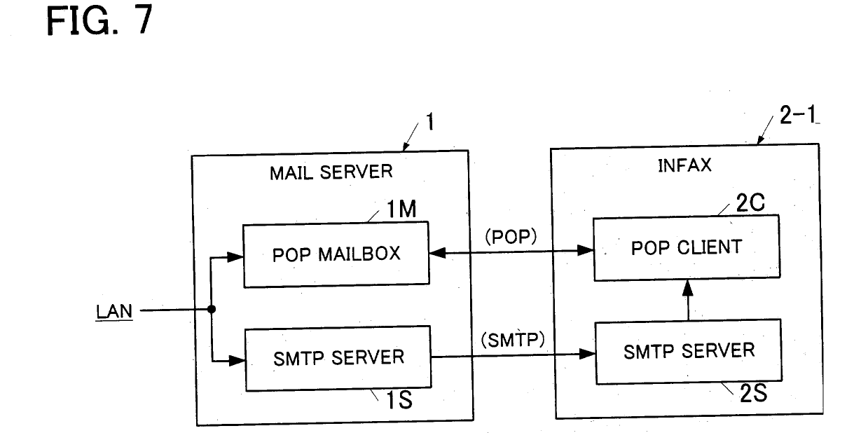

FIG. 7 is a functional block diagram which schematically shows a communication function of electronic mail between the mail server 1 and the INFAX 2-1 (same for the INFAX 2-2), to describe the protocol of the electronic mail communication to be carried out between the mail server 1 and the INFAX 2-1 (same for the INFAX 2-2).

The mail server 1 functionally includes a POP mailbox 1M, and an SMTP server 1S. The electronic mail received by the mail server 1 from a remote device, specifically the LAN 3, is stored to the POP mailbox 1M. The POP mailbox 1M is specifically the above-described mailbox 150 set in the HD 15. Moreover, the SMTP server 1S of the mail server 1 is a function realized as software by the control unit 10. When the mail server 1 receives electronic mail from the remote device, specifically the LAN 3, a new mail notification of the electronic mail is transmitted by the SMTP to the destination of the electronic mail (for example, the INFAX 2-1). The electronic mail of the new mail notification has simple contents and the amount of data is extremely small.

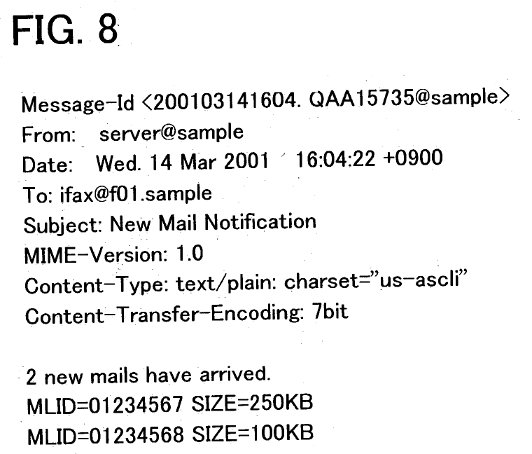

FIG. 8 is a schematic diagram showing an example of the new mail notification. In this example, it is notified that there are two new electronic mails in the mail server 1, and that the amount of the data of each of the new electronic mail is 250 KB and 100 KB respectively.

Meanwhile, the INFAX 2-1 (same for the INFAX 2-2) functionally includes a POP client 2C and an SMTP server 2S. The SMTP server 2S is a function realized as software by the control unit 20. The SMTP server 2S receives electronic mail of a new mail notification (an example is shown in FIG. 8) transmitted from the SMTP server 1S of the mail server 1 by the SMTP. Meanwhile, the POP client 2C is a function realized as software by the control unit 20. When receiving a new mail notification, the POP client 2C carries out polling to the POP mailbox 1M of the mail server 1 to request the electronic mail stored in the POP mailbox 1M to be distributed by the POP.

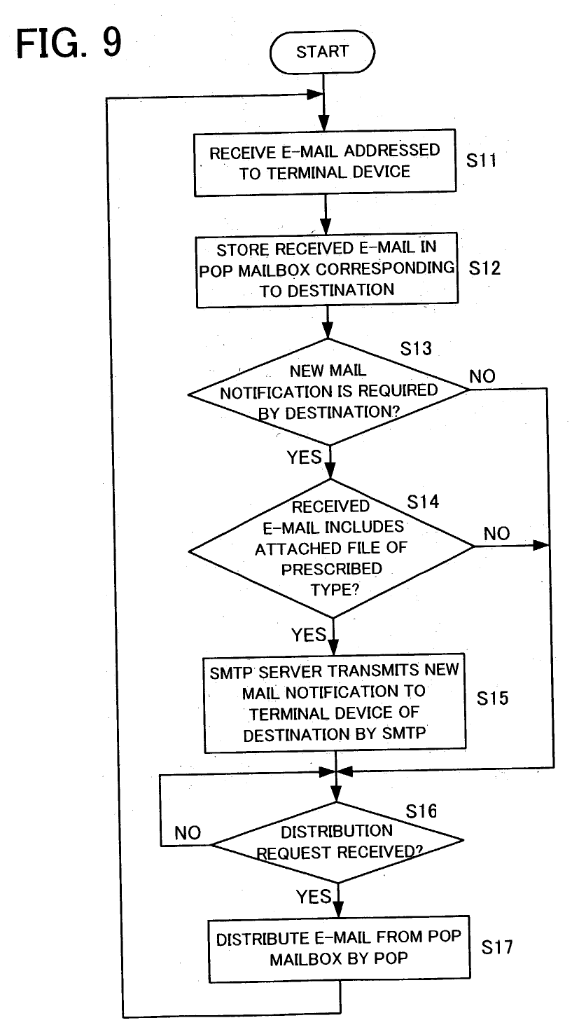

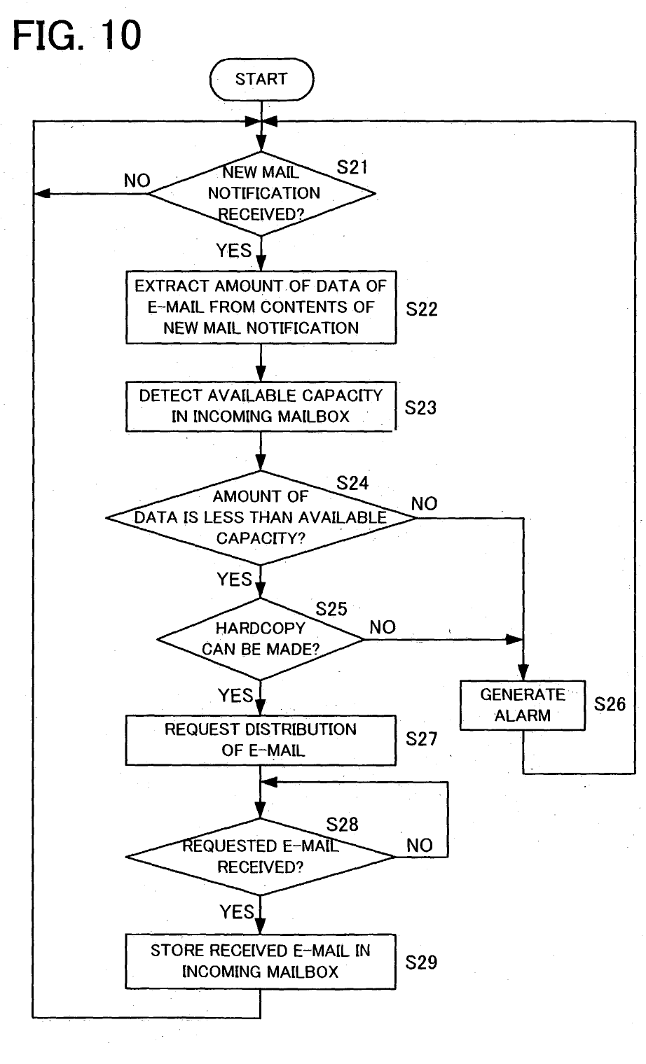

Next, referring to the flowcharts shown in FIG. 9 and FIG. 10, an operation of the mail server 1 and the INFAX 2-1 (same for the INFAX 2-2) will be described.

When receiving an electronic mail addressed to another terminal device, specifically the INFAX 2-1, 2-2, etc., from the LAN 3 (step S11), the control unit 10 of the mail server 1 stores the received electronic mail in either one of the mailboxes 151 or 152 of the POP mailbox 1M (specifically, the mailbox 150 of the HD 15) corresponding to the destination, without distributing the received electronic mail immediately (step S12).

Then, the control unit 10 determines whether or not a new mail notification is required by the electronic mail address of the destination of the received electronic mail in accordance with the registered contents of the mailbox management table 160 (step S13). When the new mail notification is required (YES in step S13), the type of the received electronic mail is determined (step S14). Specifically, it is determined whether or not the received electronic mail is a reception confirmation mail for the electronic mail transmitted previously, and whether or not the received electronic mail is attached with an attached file. When an attached file is attached, the type of the file (data format) is determined.

Here, when the received electronic mail is a reception confirmation mail, or when the received electronic mail is not attached with an attached file, the contents of the received electronic mail are generally only character codes. Thus, the amount of data generally does not become a problem. Moreover, even when an attached file is attached to the received electronic mail, if the attached file is a normal document file, since the contents, are generally only character codes, the amount of data generally does not become a problem. However, when the attached file is an image file (or a file in a format converted into character data from an image file), the amount of data is generally relatively large. In this case, if the received electronic mail is distributed to the destination immediately, there is a possibility for the amount of data to cause problems.

Therefore, when the received electronic mail includes an attached file of a prescribed type (data format), specifically an image file (or a file in a format converted into character data from an image file) (YES in step S14), the SMTP server 1S of the mail server 1 transmits a new mail notification of electronic mail as shown in FIG. 8 to the destination of the received electronic mail by the SMTP (step S15). As described above, since the electronic mail of the new mail notification is transmitted by the SMTP which is the push method protocol, the new mail notification is distributed to a terminal device of the destination of the electronic mail, for example, the INFAX 2-1, at the same time as when the mail server 1 receives the electronic mail.

Further, when the new mail notification is not required by the electronic mail address of the destination of the received electronic mail (NO in step S13), or when the received electronic mail is not an electronic mail attached with an attached file of a prescribed type (NO in step S14), the POP mailbox 1M of the mail server 1 is on standby to receive a distribution request for the electronic mail (step S16). When receiving a distribution request (YES in step S16), the requested electronic mail is distributed from the POP mailbox 1M by the POP (step S17).

Meanwhile, as shown in FIG. 10, the SMTP server 2S of the INFAX 2 (INFAX 2-1) is always on standby to receive a new mail notification from the mail server 1 by the SMTP (step S21). When receiving a new mail notification (YES in step S21), the SMTP server 2S extracts the amount of data of the electronic mail from the contents of the new mail notification (step S22). At the same time, the SMTP server 2S detects the available capacity in the incoming mailbox 340 which is set within a prescribed area in the HD 33 (step S23). Then, the SMTP server 2S compares the available capacity with the amount of data extracted in advance from the new mail notification (step S24).

Further, when comparing in step S24, the amount of data extracted from the new mail notification can be compared with a prescribed amount, instead of comparing with the available capacity in the incoming mailbox 340. For example, when there is a setting to immediately make a hardcopy of the received electronic mail by the printing unit 23, since the incoming mailbox 340 of the INFAX 2-1 is always available, the capacity of the incoming mailbox 340 can be made as the prescribed amount.

As a result of the comparison, when the available capacity in the incoming mailbox 340 is larger than the amount of data of the electronic mail notified by the new mail notification (YES in step S24), it is determined whether or not the SMTP server 2S can make a hardcopy, specifically, it is determined whether or not the SMTP server 2S can make a hardcopy of the received electronic mail, especially the attached file (step S25). Specifically, the control unit 20 mainly detects a presence or an absence of recording paper, a presence or an absence of toner, a presence or an absence of a paper jam or the like in the printing unit 23 to determine whether or not the printing unit 23 can actually make a hardcopy.

As a result of the determination in step S25, when it is determined that the printing unit 23 can make a hardcopy of an electronic mail (YES in step S25), the POP client 2C carries out polling to request the POP mailbox 1M of the mail server 1 to distribute the electronic mail (step S27). Further, as a result of the comparison in step S24, when the amount of the data of the electronic mail is equal to or more than the available capacity of the incoming mailbox 340, the electronic mail cannot be received (NO in step S24). As a result of the determination in the step S25, when it is determined that there is no recording paper, toner or the like in the printing unit 23, a hardcopy of the electronic mail cannot be made (NO in step S25). Therefore, in these cases, the control unit 20 generates an appropriate alarm (step S26). For example, a buzzer can be sounded, or a message can be displayed on the display unit 27 indicating the fact that although an electronic mail has arrived at the mail server 1, the electronic mail cannot be received. Alternatively, a paper indicating the same fact can be printed out from the printing unit 23 (only when NO in step S24).

The POP mailbox 1M of the mail server 1 is on standby to receive a distribution request from the POP client 2C of the INFAX 2-1 (step S16). When receiving the distribution request transmitted from the INFAX 2-1 as described above (YES in step S16), the requested electronic mail is distributed from the POP mailbox 1M to the INFAX 2-1 by the POP (step S17).

The POP client 2C of the INFAX 2-1 is on standby to receive the electronic mail which the INFAX 2-1 requested the mail server 1 to distribute (step S28). When receiving the electronic mail (YES in step S28), the received electronic mail is stored to the incoming mailbox 340 set within the HD 33 (step S29). Further, the received electronic mail can be stored to the incoming mailbox 340, and also made as a hardcopy by the printing unit 23 immediately.

In the above-described embodiment, the SMTP is used as the push method electronic mail protocol, and the POP is used as the pull method electronic mail protocol. However, each of the protocols is not limited to these specific protocols.

Moreover, in the above-described embodiment, a designation of the destination which needs the new mail notification was made to the mail server 1, and the new mail notification was made only to the electronic mail which has an attached file. However, the present invention is not limited to this example, and either one of the conditions can be set. In addition, the new mail notification can be carried out for all incoming electronic mails, not only to some of the electronic mails that satisfy a prescribed condition.

What is claimed is:

1. A mail server comprising:
a mailbox which stores received electronic mail by corresponding each of the electronic mail and an electronic mail address of a destination;
means for transmitting electronic mail of a new mail notification to the electronic mail address of the destination of a received electronic mail by a push method protocol; and
means for distributing the electronic mail by a pull method protocol in accordance with a distribution request from the electronic mail address of the destination of the electronic mail stored in the mailbox.

2. The mail server according to claim 1, wherein the push method protocol is a Simple Mail Transfer Protocol (SMTP).

3. The mail server according to claim 1, wherein the pull method protocol is a Post Office Protocol (POP).

4. The mail server according to claim 1, wherein when the electronic mail address of the destination of the received electronic mail is an electronic mail address designated in advance, the means for transmitting transmits electronic mall of a new mail notification by the push method protocol.

5. The mail server according to claim 4, further comprising:
means for registering whether or not to carry out the new mail notification to each of a plurality of electronic mail addresses;
wherein the means for transmitting determines whether or not to carry out a new mail notification in accordance with registered contents of the means for registering.

6. The mail server according to claim 4, wherein the push method protocol is a Simple Mail Transfer Protocol (SMTP).

7. The mail server according to claim 1, wherein the means for transmitting determines whether or not to transmit the electronic mail of the new mail notification by the push method protocol in accordance with a type of the received electronic mail.

8. The mail server according to claim 7, wherein the means for transmitting determines not to transmit the electronic mail of the new mail notification by the push method protocol when the received electronic mail is a reception confirmation mail of electronic mail transmitted previously.

9. The mail server according to claim 7, wherein the means for transmitting determines not to transmit the electronic mail of the new mail notification by the push method protocol when the received electronic mail is an electronic mail not attached with an attached file.

10. The mail server according to claim 7, wherein the push method protocol is a Simple Mail Transfer Protocol (SMTP).

11. The mail server according to claim 1, where in the means for transmitting transmits the electronic mail of the new mail notification by the push method protocol when the type of the received electronic mail is an electronic mail of a type designated in advance.

12. The mail server according to claim 11, wherein the means for transmitting transmits the electronic mail of the new mail notification by the push method protocol when the received electronic mail is an electronic mail which a file of a prescribed type is attached as an attached file.

13. The mail server according to claim 12, wherein the file of the prescribed type is an image file or a file in a format converted into character data from the image file.

14. The mail server according to claim 11, wherein the push method protocol is a Simple Mail Transfer Protocol (SMTP).

15. The mail server according to claim 1, wherein the means for transmitting notifies an amount of data of the received electronic mail by electronic mail of a new mail notification.

16. An electronic mail receiving terminal device comprising:
means for receiving electronic mail of a new mail notification which notifies that an electronic mail is stored in a mailbox of a mail server by a push method protocol; and
means for requesting the mail server to distribute the electronic mail by a pull method protocol when receiving the new mail notification.

17. The electronic mail receiving terminal device according to claim 16, wherein the push method protocol is a Simple Mail Transfer Protocol (SMTP).

18. The electronic mail receiving terminal device according to claim 16, wherein the pull method protocol is a Post Office Protocol (POP).

19. The electronic mail receiving, terminal device according to claim 16, further comprising:
a printing unit which prints the received electronic mail as a hardcopy;
wherein the means for requesting request the mail server to distribute electronic mail by the pull method protocol when the printing unit can execute a printing operation, and when the new mail notification is received.

20. The electronic mail receiving terminal device according to claim 19, wherein the pull method protocol is a Post Office Protocol (POP).

21. The electronic mail receiving terminal device according to claim 16, further comprising:
means for storing the received electronic mail;
wherein the means for requesting request the mail server to distribute the electronic mail by the pull method protocol when an available capacity in the means for storing is a prescribed capacity or more, and when the new mail notification is received.

22. The electronic mail receiving terminal device according to claim 21, wherein the pull method protocol is a Post Office Protocol (POP).

23. The electronic mail receiving terminal device according to claim 16, further comprising:
means for storing the received electronic mail; and
means for comparing an amount of data notified by the received electronic mail of the new mail notification, and an available capacity in the means for storing when the new mail notification is received;
wherein the means for requesting requests the mail server to distribute the electronic mail by the pull method protocol when the amount of data notified by the new mail notification is smaller than the available capacity in the means for storing.

24. The electronic mail receiving terminal device according to claim 23, wherein the pull method protocol is a Post Office Protocol (POP).

25. The electronic mail receiving terminal device according to claim 16, further comprising:
means for storing the received electronic mail; and
means for comparing an amount of data notified by the received electronic mail of the new mail notification, and a prescribed amount when the new mail notification is received;
wherein the means for requesting requests the mail server to distribute the electronic mail by the pull method protocol when the amount of the data notified by the new mail notification is smaller than the prescribed amount.

26. The electronic mail receiving terminal device according to claim 25, wherein the pull method protocol is a Post Office Protocol (POP).
